(19) United States
(12) Patent Application Publication
(10) Pub. No.: US 2026/0287476 A1
(43) Pub. Date: Sep. 24, 2026

(54) Sampling Device and Method for Taking Samples

(71) Applicant: GLATT GESELLSCHAFT MIT BESCHRÄNKTER HAFTUNG, Binzen (DE)

(72) Inventors: Jochen Thies, Lörrach (DE); Dirk Zimmermann, Wehr (DE); Heinz Gottschling, Weil am Rhein (DE)

(21) Appl. No.: 19/477,542

(22) PCT Filed: Feb. 27, 2024
(86) PCT No.: PCT/EP2024/054939

§ 371 Date: Oct. 22, 2025

(30) Foreign Application Priority Data
Apr. 27, 2023 (DE) 10 2023 110 937.5

(51) Int. Cl. G01N 1/20

(52) U.S. Cl. CPC G01N 1/2035; G01N 2001/205; G01N 2001/2071

(57) ABSTRACT

A sampling device a sampler which has a sampler housing on which a sample outlet is formed which can be optionally opened or closed by a valve element. A sample vessel to be filled with a sample can be attached to the sampler with the interposition of an adapter/plug unit consisting of a vessel adapter and a closure plug. By attaching the closure plug of the mounted adapter/plug unit to the valve element, a vessel interior of the sample vessel can be accessed by actuating the valve element in order to introduce a sample and then closed again. The adapter/plug unit can be removed from the sampler together with the sample vessel while securely enclosing a sample, with it functioning as a closure cap for the sample vessel. Also described is a method of sampling using the sampling device.

### CROSS-REFERENCE TO RELATED APPLICATIONS

This application is the United States national phase of International Patent Application No. PCT/EP2024/054939 filed Feb. 27, 2024, and claims priority to German Patent Application No. 10 2023 110 937.5 filed Apr. 27, 2023, the disclosures of which are hereby incorporated by reference in their entireties.

### BACKGROUND

### Field

The invention relates to a sampling device, in particular for sampling from a containment area, with a sampler that comprises a sampler housing which defines a sample collection chamber for receiving a sample to be taken and which has a sample inlet communicating with the sample collection chamber for introducing a sample to be taken, and a sample outlet communicating with the sample collection chamber for discharging the sample contained in the sample collection chamber into a sample vessel fixed to the sampler and defining a vessel interior.

Furthermore, the invention relates to a method for sampling, in particular from a containment area, using a sampling device with a sampler that comprises a sampler housing which defines a sample collection chamber for receiving a sample to be taken and which has a sample inlet communicating with the sample collection chamber for introducing a sample to be taken, and a sample outlet communicating with the sample collection chamber for discharging the sample contained in the sample collection chamber into a sample vessel fixed to the sampler and defining a vessel interior,
wherein,
   that the sampler has a valve member which is movable relative to the sampler housing to selectively open or close the sample outlet by performing valve element movements, which comprises a closure section which, in a valve element closure position, seals the sample outlet tightly and, in a valve element open position, is displaced into the sample collection chamber and clears the sample outlet for sample passage,
   that the sampling device comprises a sleeve-shaped vessel adapter which can be attached or is attached to the sample vessel in a vessel position in the area of a vessel opening, which is traversed axially by an adapter opening connected to the vessel interior in the vessel position,
   that the sampling device comprises a closure plug which can be moved both into a plug closure position inserted into the adapter opening and thereby tightly sealing the adapter opening and into a plug open position pulled out of the adapter opening and thereby clearing the adapter opening, wherein the vessel adapter and the closure plug together form an adapter-plug unit in the plug closure position,
   that parts of a plug connection device are arranged on the valve element and on a fastening section of the closure plug, by means of which the closure plug can be detachably fastened to the valve element in a plug coupling position, in which the closure plug follows the valve element movements of the valve element,
   and that parts of an adapter connection device are arranged on the sampler housing and on the vessel adapter, by means of which the vessel adapter can be detachably fastened to the sampler housing in an adapter coupling position, in which the adapter opening is connected to the sample outlet,
   wherein, while the valve element is in the valve element closure position, the closure plug can be brought into the plug coupling position attached to the valve element and the vessel adapter can be brought into the adapter coupling position attached to the sampler housing, forming the adapter-plug unit, so that the adapter-plug unit is attached to the sampler on the one hand via the sampler housing and on the other hand via the valve element,
   wherein the adapter opening can initially be cleared by valve element movements of the valve element due to the closure plug moving with the valve element, so that a sample contained in the sample collection chamber can be transferred to a sample vessel arranged on the vessel adapter and enclosed therein,
   wherein the adapter-plug unit is detached in the valve element closure position of the valve element while maintaining the plug closure position of the closure plug by releasing both the adapter connection device and the plug connection device together with a sample vessel attached to the vessel adapter from the sampler, wherein the sampler is connected in a position of use with its sample inlet to a media container which contains a flowable medium, in particular a granule-or powdered medium, from which a sample is to be taken.

### Description of Related Art

In chemical or pharmaceutical production processes, free-flowing media in the form of granules or powder often need to be processed. For example, tablets are pressed from granules of varying compositions, which are provided using fluidizing apparatus and, in particular, fluidized bed apparatus. It is not uncommon for parts of the processed media to be toxic in nature, so contamination of the process environment must be avoided at all costs. The process operations therefore usually take place in a containment area, which means that protective measures are taken to minimise the risk of process media spreading, but also, conversely, of external contamination of the process media. Containment is usually ensured through the use of closed systems. Nevertheless, the processes require occasional access to the processed media, for example to regularly check the material composition and/or compliance with certain quality standards. This is done by means of sampling using a suitable sampling device. According to the applicant's internal knowledge, a sampling device can comprise a sampler that is stationary or, if necessary, attached to a media container that contains a medium to be examined, for example granules with pharmaceutical active ingredients. The sampler defines a sample collection chamber into which a quantity of the medium to be examined can be introduced from the associated media container as a sample by briefly opening an outlet opening of the media container. The sample is then transferred to a sample vessel that can be fixed to the sampler and, using this sample vessel, is fed to the subsequent tests to be carried out. In these processes, it always involves a relatively large amount of effort to reliably comply with the desired containment requirements.

### SUMMARY

The invention is based on the problem of providing a sampling device that enables containment-safe sampling with a cost-effective design and simple handling. Furthermore, an efficient method for sampling using the sampling device is to be proposed.

To solve this problem, the invention provides a sampling device which, in connection with the features mentioned above, is characterised by the following,
that the sampler has a valve member which is movable relative to the sampler housing to selectively open or close the sample outlet by performing valve element movements, which comprises a closure section which, in a valve element closure position, seals the sample outlet tightly and, in a valve element open position, is displaced into the sample collection chamber and clears the sample outlet for sample passage,
that the sampling device comprises a sleeve-shaped vessel adapter which can be attached or is attached to the sample vessel in a vessel position in the area of a vessel opening, which is traversed axially by an adapter opening connected to the vessel interior in the vessel position,
that the sampling device comprises a closure plug which can be moved both into a plug closure position inserted into the adapter opening and thereby tightly sealing the adapter opening and into a plug open position pulled out of the adapter opening and thereby clearing the adapter opening, wherein the vessel adapter and the closure plug together form an adapter-plug unit in the plug closure position,
that parts of a plug connection device are arranged on the valve element and on a fastening section of the closure plug, by means of which the closure plug can be detachably fastened to the valve element in a plug coupling position, in which the closure plug follows the valve element movements of the valve element,
and that parts of an adapter connection device are arranged on the sampler housing and on the vessel adapter, by means of which the vessel adapter can be detachably fastened to the sampler housing in an adapter coupling position, in which the adapter opening is connected to the sample outlet,
wherein, while the valve element is in the valve element closure position, the closure plug can be brought into the plug coupling position attached to the valve element and the vessel adapter can be brought into the adapter coupling position attached to the sampler housing, forming the adapter-plug unit, so that the adapter-plug unit is attached to the sampler on the one hand via the sampler housing and on the other hand via the valve element,
wherein the adapter opening can initially be cleared by valve element movements of the valve element due to the closure plug moving with the valve element, so that a sample contained in the sample collection chamber can be transferred to a sample vessel arranged on the vessel adapter and enclosed therein,
wherein the adapter-plug unit is detached in the valve element closure position of the valve element while maintaining the plug closure position of the closure plug by releasing both the adapter connection device and the plug connection device together with a sample vessel attached to the vessel adapter from the sampler.

Furthermore, the problem is solved by a sampling method in which, in connection with the measures mentioned above, a sampling device designed in the aforementioned sense is used with the following steps:
providing a sample vessel, a vessel adapter and a closure plug,
positioning the valve element of the sampler in the valve element closure position,
manually fastening the closure plug in the plug coupling position to the valve element in the valve element closure position by means of the plug connection device,
subsequently manually fastening the vessel adapter in the adapter coupling position in the area of the sample outlet of the sampler housing using the adapter connection device, wherein the pre-assembled closure plug is inserted into the adapter opening of the vessel adapter to be in the plug closure position, so that the adapter opening is closed by the closure plug, forming the adapter-plug unit,
attaching the sample vessel to the vessel adapter before or after it is fastened in the adapter coupling position,
transferring a sample introduced into the sample collection chamber from the sample collection chamber into the sample vessel fixed to the sampler housing via the vessel adapter, by first clearing and then closing the adapter opening by means of valve element movements of the valve element as a result of the closure plug following the valve element movements, so that the sample contained in the sample collection chamber is transferred through the opened adapter opening into the sample vessel and enclosed in its interior,
removing the sample vessel from the sampler together with the adapter-plug unit, which now functions as a closure cap, in the valve element closure position of the valve element, by detaching both the adapter connection device and the plug connection device while maintaining the plug closure position of the closure plug.

The sampling device according to the invention allows regular sampling from a containment area with a high degree of safety against contamination of the surroundings and against contamination of the medium to be examined. The sampling device has a sampler which, during use, is attached in a position of use with a sample inlet to a media container containing a flowable and, for example, granular medium which is to be removed in portions for examination. A dispensing device on the media container or sampler, for example in the form of a shut-off valve, allows the desired quantity of medium to be dispensed into a sample collection chamber of the sampler confined by a sampler housing. This medium discharge can take place in a hermetically sealed state of the sample collection chamber, which is ensured by the fact that a sample outlet communicating with the sample collection chamber is tightly closed by a valve element of the sampler positioned in a valve element closure position. A sample vessel intended to receive this sample can be detachably attached to the sampler housing in the area of the sample outlet by means of a fastening element referred to as a vessel adapter, for which purpose the sampler housing and the vessel adapter are equipped with matching parts of a connecting device referred to as an adapter connection device. For better differentiation, the position taken by the vessel adapter when attached to the sampler housing is referred to as the adapter coupling position. The vessel adapter is sleeve-shaped and has an adapter opening running through it axially, which allows access to the interior of the sample vessel attached to the vessel adapter. This adapter opening is assigned a closure plug, which also belongs to the sampling device and can selectively be inserted into the adapter opening in a plug closure position or arranged outside the adapter opening in a plug open position. When the closure plug is inserted into the adapter opening, it closes the adapter opening and, together with the vessel adapter, forms a uniformly usable unit, which is referred to as the adapter-plug unit. The closure plug has a fastening section by means of which it can be detachably fastened to the valve element using a connecting device referred to as a plug connection device. The position of the closure plug when attached to the valve element is referred to as the plug coupling position for better differentiation. When the valve element is moved to open or close the sample outlet, the closure plug fixed to the valve element in the plug coupling position always follows the valve element movements immediately. In order to transfer a sample located in the sample collection chamber to the sample vessel in a containment-safe manner, the vessel adapter and the closure plug can be attached to the sampler housing or to the valve element in the closure position in such a way that the adapter-plug unit is present, meaning that the sample vessel is attached to the sampler housing via the vessel adapter and the closure plug currently closing the adapter opening is attached to the valve element. Subsequently, valve element movements of the valve element can be induced, in particular manually or also automatically, by which the valve element is first moved from the valve element closure position to the valve element open position and then back to the valve element closure position. Since the closure plug follows these valve element movements, the adapter opening is cleared when the valve element is in the open position. This allows the sample filled into or already contained in the sample collection chamber to pass through the now open adapter opening into the sample vessel. The valve element open position can be maintained as long as the entire sample has passed through or been removed from the sample collection chamber. After the valve element has been moved back to the valve element closure position, the adapter-plug unit is once again present, wherein the closure plug has closed the adapter opening again. The transferred sample is thus contained in the sample vessel in a containment-safe manner and sealed off from the environment. By subsequently loosening both the adapter connection device and the plug connection device, the adapter-plug unit can be separated from the sampler together with the sample vessel without the interior of the sample vessel or the sample collection chamber of the sampler coming into contact with the environment. The removed adapter-plug unit now functions as a closure cap for continued containment-safe handling of the sample until its intended use.

The sampling method in particular allows the medium to be sampled to be filled into the sample collection chamber with the valve element in the closure position before or after the attachment of the adapter-plug unit to the sampler. However, it is also possible to fill the sample into the sample collection chamber with the valve element in the open position, after the adapter-plug unit has been attached to the sampler. In this case, the sample passes through the sample collection chamber without being retained in it.

Advantageous embodiments of the invention are disclosed in the dependent claims.

The closure section of the valve element is expediently designed like a plug. This allows the closure section to immerse in the sample outlet in the valve element closure position and to radially abut against an inner circumferential surface surrounding the sample outlet. This ensures a particularly high sealing quality with radial sealing force that is independent of external influences.

The plug connection device and the adapter connection device are preferably designed in such a way that they can be detached simultaneously from the sampler in order to separate the adapter-plug unit. This facilitates handling. In particular, the separation can be carried out as part of a uniform, manually initiated detachment movement of the adapter-plug unit. In principle, however, an embodiment would also be possible in which, for example, the connection between the closure plug and the valve element is first detached and only then the connection between the vessel adapter and the sampler housing.

It is also advantageous if the adapter-plug unit can be detached from the sampler by a single detach action of the vessel adapter from both the sampler housing and the valve element. In this case, the closure plug is mechanically coupled to the vessel adapter in such a way that no direct manipulation can be performed on it to detach it from the valve element. The closure plug is actuated here by the vessel adapter.

Both the plug connection device and the adapter connection device could, for example, be designed as a connection device based on a latching or other type of locking mechanism. How-ever, a screw connection device is considered to be particularly cost-effective and reliable. In this case, the plug connection device has a first plug thread formed on the closure plug and a second plug thread formed on the valve element that is complementary to it. Furthermore, the adapter connection device has a first adapter thread formed on the vessel adapter and a second adapter thread formed on the sampler housing that is complementary to it. By rotating the closure plug, the first and second plug threads can be brought into or out of mutual engagement, depending on the direction of rotation, and by rotating the vessel adapter, the first and second adapter threads can be brought into or out of mutual engagement, depending on the direction of rotation, in order to establish or release the associated screw connection.

The adapter plug unit, consisting of the vessel adapter and the closure plug inserted into the vessel adapter, has a central longitudinal axis, relative to which the vessel adapter and the closure plug are arranged coaxially. Preferably, the two plug threads and the two adapter threads are also arranged coaxially with respect to the central longitudinal axis of the adapter plug unit.

It is advantageous if the first plug thread is an internal thread and the second plug thread is an external thread. For example, the second plug thread can be designed as an external thread on a fastening bolt of the valve element, onto which the closure plug can be screwed, which comprises a fastening hole with an internal thread that allows the fastening bolt to be inserted. The interaction between the fastening bolt and the fastening hole can also achieve a centring effect for the precise alignment of the closure plug.

It is advantageous if the two plug threads have the same thread pitch as the two adapter threads. This makes it possible to disengage both plug threads and both adapter threads simultaneously with a single loosening rotation of the adapter-plug unit in order to unscrew the adapter-plug unit from the sampler.

The screw connection measures can be handled more easily if the adapter-plug unit comprises a free wheel unit. The free wheel unit is designed in particular so that, on the one hand, the vessel adapter can rotate freely relative to the fastening section of the closure plug, when a torque is applied to the vessel adapter in a fastening direction of rotation in order to fasten it to the sampler housing. This allows the vessel adapter to be fastened to the sampler housing via the adapter connection device independently of the closure plug already screwed onto the valve element. On the other hand, the free wheel unit causes the vessel adapter to take the closure plug with it when a torque is applied that is oriented in a loosening direction of rotation opposite to the fastening direction of rotation, so that the screw connections of the adapter connection device and the plug connection device are loosened simultaneously. The free wheel unit thus causes torque to be transmitted in only one of the two possible directions of rotation, which on the one hand allows the vessel adapter to be screwed on without being hindered by the pre-mounted closure plug and on the other hand allows the closure plug to be unscrewed together with the vessel adapter.

In one possible embodiment, the free wheel unit is effective between the vessel adapter and the closure plug. First and second blocking elements of the free wheel unit are arranged on the vessel adapter and on the closure plug and, depending on the direction of rotation, cause a torque to be transmitted or not transmitted between the two components. This embodiment of a free wheel requires very few components and can therefore be implemented very cost-effectively.

Alternatively, the free wheel unit can be integrated either into the vessel adapter or into the closure plug. In this case, the component equipped with the free wheel unit, i.e. either the vessel adapter or the closure plug, comprises a first free wheel element and a second free wheel element that can rotate in relation to it, which are equipped with first and second blocking elements that can be locked and unlocked depending on the direction of rotation. Between the second free wheel element and the component that does not comprise a free wheel unit, depending on the design of the closure plug or the vessel adapter, a follower structure is addition-ally effective, which causes the second free wheel element to be driven in both directions of rotation when the component that does not comprise a free wheel unit is rotated.

If, in the preferred embodiment, the closure plug is equipped with the integrated free-wheel unit, it is expediently for the first free wheel element to comprise the fastening section that can be used to fix the closure plug to the valve element and for the second free wheel element to be coupled to the vessel adapter in both directions of rotation via the aforementioned follower structure in a manner that transmits torque. This means that when the vessel adapter is screwed onto the sampler housing, the free-wheel function is effective, wherein the vessel adapter and the second free wheel element can rotate together relative to the fastening section that is already screwed tight, whereas when the vessel adapter is unscrewed, the second free wheel element, which is again driven, is or becomes coupled to the first free wheel element and accordingly also to the fastening section in a torque-transmitting manner, so that the fastening section and thus the entire closure plug can be unscrewed together with the vessel adapter.

Preferably, the first blocking elements are formed by a tooth structure that is radially immovable relative to the aforementioned central longitudinal axis of the adapter-plug unit, while the second blocking elements are formed by latch elements that are radially spring-elastic relative to the central longitudinal axis of the adapter-plug unit. This arrangement may also be reversed. For example, the latch elements consist of a spring-elastic deformable metal or plastic.

The use of the plural when naming the blocking elements and latch elements is intended to include the possibility of providing only one of these elements in each case.

A particularly secure connection between the adapter-plug unit is achieved when the closure plug is detachably locked in the plug closure position with the vessel adapter. Locking is preferably achieved by means of an annular seal, for example an O-ring, between the closure plug and the vessel adapter to ensure sealing, which is preferably formed on the closure plug and engages in an annular groove of the vessel adapter, or vice versa.

It is advantageous if the closure plug comprises a sealing surface on the end face facing the valve element in the plug coupling position, which, in the plug coupling position, rests axially against the closure section of the valve element and thus prevents the end face of the closure section obtains contact with the sample in the valve element open position. This protective function can be performed particularly reliably if the end-face sealing surface is concave in shape, thus creating a particularly high surface pressure at the outer peripheral area of the sealing surface.

The valve element is preferably provided with an actuating rod that protrudes from the sampler housing and carries the closure section, to which an actuating force can be applied manually or by motor in order to induce the valve element movement. The actuating rod has a longitudinal section extending into the sample collection chamber, which is expediently enclosed by a rubber-elastic, deformable sealing collar, which reliably prevents material from escaping between the sampler housing and the actuating rod. The sealing collar is axially secured on one side to the closure section and on the other side to the sampler housing and is expediently has a bellows structure.

The sampler comprises an imaginary vertical axis, relative to which the sample outlet is expediently arranged coaxially and which is preferably aligned at least substantially vertically in a position of use of the sampler, so that the sample contained in the sample collection chamber is reliably transferred by gravity into the attached sample vessel when the sample outlet is opened.

The sampler housing is expediently equipped with a gas-tight inspection glass, which is made of transparent glass or plastic, for example, and allows the sample collection chamber to be viewed from the outside. This allows visual inspection of the media fill level in the sample collection chamber and whether the entire sample has reliably left the sample collection chamber after opening the sample outlet.

For easier handling, it is advantageous if the valve element is assigned a locking-in-place device that allows the valve element to be detachably fixed in the valve element open position or in the valve element closure position, and preferably in both of these positions.

### BRIEF DESCRIPTION OF THE DRAWINGS

The terms Fig., Figs., Figure, and Figures are used interchangeably in the specification to refer to the corresponding figures in the drawings.

The invention is explained in more detail below with reference to the accompanying drawing.

This shows:

FIG. 1 a side view of a preferred first embodiment of the sampling device according to the invention, wherein a media container equipped with the sampling device is only schematically indicated,

FIG. 2 the sampling device from FIG. 1 in a longitudinal section with the valve element in its valve element closure position,

FIG. 3 the detailed section III outlined with dotted lines in FIG. 2 in an enlarged view,

FIG. 4 a cross-section of the sampling device according to section line IV-IV from FIGS. 2 and 3,

FIG. 5 a further longitudinal section of the sampling device, wherein the valve element is shown in its valve element open position,

FIG. 6 on section, an exploded view of the area illustrated in FIG. 3 of the first embodiment of the sampling device,

FIG. 7 a single view of the closure plug of the sampling device of the first embodiment in a viewing direction according to arrow VII from FIG. 8, wherein, in order to illustrate the follower function of the follower structures, the vessel adapter surrounding the closure plug in the plug closure position is additionally indicated by dotted lines,

FIG. 8 the closure plug from FIG. 7 in a side view with the viewing direction indicated by arrow VIII,

FIG. 9 a longitudinal section of the closure plug according to section line IX-IX from FIGS. 7 and 12,

FIG. 10 a cross-section of the closure plug according to section line X-X from FIGS. 7, 8 and 9,

FIG. 11 an axial front view of the closure plug with the viewing direction according to arrow XI in FIGS. 7 and 8,

FIG. 12 a rear view of the closure plug with the viewing direction indicated by arrow XII in FIGS. 7 and 8,

FIG. 13 a perspective single view of the vessel adapter of the first embodiment of the sampling device with a view of its front side,

FIG. 14 a side view of the vessel adapter from FIG. 13,

FIG. 15 a longitudinal section of the vessel adapter along section line XV-XV from FIG. 14,

FIG. 16 a front view of the vessel adapter with the viewing direction indicated by arrow XVI from FIG. 13,

FIG. 17 an exploded view of components of a second embodiment of the sampling device according to the invention, corresponding to FIG. 6, which distinguishes itself from the first embodiment only in the embodiment of the vessel adapter and the closure plug, so that, apart from this, the structure of this sampling device corresponds in particular to that shown in FIGS. 1, 2 and 5, wherein the longitudinal section of the illustrated closure plug corresponds to the section line XXVIIb-XXVIIb from FIGS. 26 and 27, and wherein the closure plug and the vessel adapter in FIG. 17 are also illustrated once again in a dotted-dash frame in the configuration assembled as an adapter-plug unit,

FIG. 18 a side view of the adapter-plug unit of the second embodiment, viewed in the direction of arrow XVIII from FIG. 17,

FIG. 19 a front view of the adapter-plug unit with the viewing direction according to arrow IX from FIG. 18,

FIG. 20 a rear view of the adapter-plug unit with the viewing direction indicated by arrow XX in FIG. 18,

FIG. 21 an isometric single view of the vessel adapter of the second embodiment,

FIG. 22 a front view of the vessel adapter with the viewing direction indicated by arrow XXII in FIG. 21,

FIG. 23 a side view of the closure plug of the second embodiment of the sampling device, viewed in the direction of arrow XXIII in FIGS. 17 and 24,

FIG. 24 another side view of the closure plug with the viewing direction indicated by arrow XXIV in FIG. 23,

FIG. 25 a cross-section of the closure plug according to section line XXV-XXV from FIG. 23,

FIG. 26 a front view of the closure plug with the viewing direction according to arrow XXVI from FIG. 23, and

FIG. 27 a rear view of the closure plug with the viewing direction indicated by arrow XXVII in FIG. 23.

### DETAILED DESCRIPTION

The sampling device 1 illustrated in the drawing in several embodiments is suitable for sampling from containment areas due to its properties, but can also be used without further ado for sampling where lower safety requirements apply.

The sampling device 1 comprises an apparatus, referred to as sampler 2, which is preferably designed as a uniform, usable unit. The sampler 2 has a sampler housing 3, which encloses an interior space functioning as a sample collection chamber 4 and has two openings, one of which forms a sample inlet 5 and the other a sample outlet 6.

The sampler 2 extends along an imaginary vertical axis 7, the direction of which is referred to as the height direction 7a. In its preferred position of use, the sampler 2 is arranged with the vertical axis 7 aligned vertically. The sample outlet 5 is located on the underside 8 of the sampler housing 3, which points downwards in the height direction 7a. In the aforementioned position of use of the sampler 2, the sample inlet 5 is located at a higher level than the sample collection chamber 4 and the sample outlet 5.

The sampler housing 3 is provided with a fastening structure 11, preferably designed as a fastening flange, by means of which the sampler 2 is attached to a media container 12, shown only schematically, when it is in its position of use. The media container 12 contains a flowable medium, for example a powder or granule, which can be intended for any process, for example for the production of tablets in the pharmaceutical sector. The sampler 2 can be used to remove portions of the medium, referred to as samples, from the media container 12 for process monitoring. The media container 12, which may be, for example, a fluidizing apparatus and, in particular, a fluidized bed apparatus, is equipped with a dispensing device 13, designed, for example, in the manner of a shut-off valve, through which the sample to be tested can be dispensed as required and fed through the sample inlet 5 into the sample collection chamber 4.

The sampler housing 3 has a housing wall 14 surrounding the sample collection chamber 4, which is made of metal or plastic, for example, and is preferably at least predominantly opaque. Expediently, a section of the housing wall 14 is designed as an inspection glass 15, which is made of a gas-impermeable and at the same time transparent material and is formed, for example, by a glass pane. In the position of use of the sampler 2, the inspection glass 15 is preferably oriented horizontally so that a person standing next to the sampler 2 can easily see into the sample collection chamber 4 through the inspection glass 15. The inspection glass 15 allows visual inspection of the sample collection chamber 4, in particular to verify the presence or absence of a sample or sample residues.

The sampling device 1 expediently contains a sample vessel 16, the purpose of which is to collect the sample taken from the medium for transport to a testing location, for example in a laboratory.

The sample vessel 16, which is designed as a bottle or cup, for example, defines a vessel interior 17 intended for sample collection, which is accessible through a vessel opening 18 and can be filled or emptied accordingly. In the area of the vessel opening 18, the sample vessel 16 is equipped with a first component 21a of a cap-connection device 21, which makes it possible to attach a closure cap 22 to the sample vessel 16 in a detachable manner in order to hermetically seal the vessel opening 18.

FIG. 2 shows a single illustration, framed by a dotted line, of a sample vessel 16 closed by an attached closure cap 22. The closure cap 22 has a second component 21b of the cap-connection device 21 that is complementary to the first component 21a, wherein these two components 21a, 21b are in engagement with each other. Preferably, the two components 21a, 21b of the cap-connection device 21 are designed as screw threads, wherein, for example, the first component 21a located on the sample vessel 16 is designed as an external thread and the second component 21b located on the closure cap 22 is designed as an internal thread. The threads may be conventional screw threads or bayonet connection structures.

To fill the sample vessel 16 with the sample contained in the sample collection chamber 4, the sample vessel 16 is attached to the sampler housing 3 in the area of the sample outlet 6 in such a way that the vessel opening 18 is aligned coaxially with the sample outlet 6. However, in both embodiments, the sample vessel 16 is not attached directly to the sampler housing 3, but indirectly via a sleeve-shaped intermediate piece referred to as a vessel adapter 23. The vessel adapter 23 is traversed axially in the centre by a through-opening referred to as the adapter opening 24, which opens both at an axial front 25a and at an axial back 25b of the vessel adapter 23.

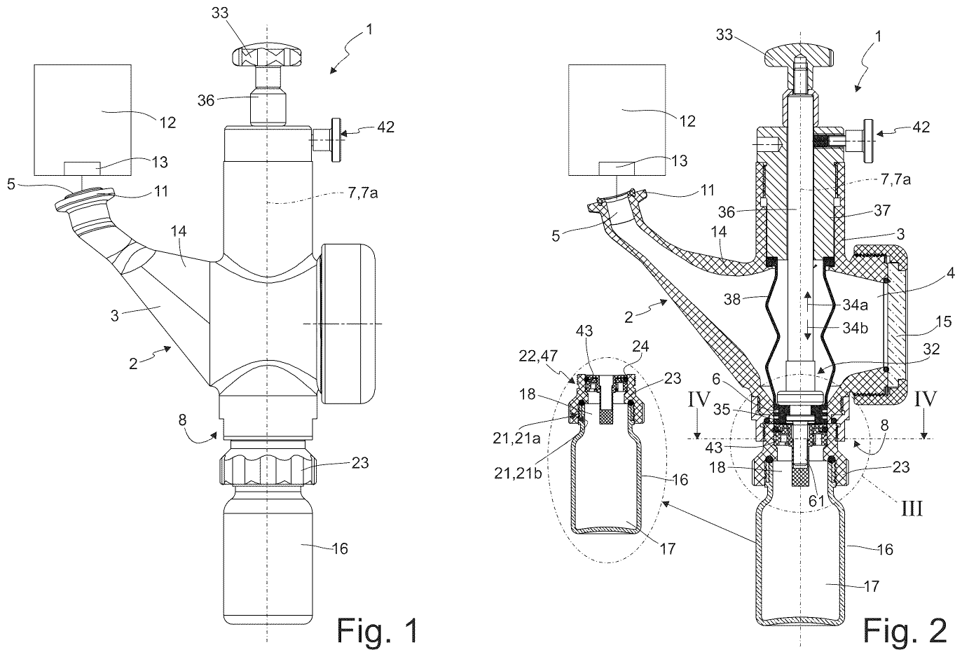

The vessel adapter 23 has a vessel fastening structure 26 in the area of its back 25b, with which it can be attached to the sample vessel 16 by interacting with the first component 21a of the cap-connection device 21, taking a vessel position as shown in FIGS. 1 to 3 and 5. The vessel fastening structure 26 corresponds in its embodiment to the second component 21b of the cap-connection device 21 described above, wherein, as illustrated in the embodiments, the vessel adapter 23 is expediently a component of the closure cap 22 and thus the vessel fastening structure 26 is formed directly by the first component 21a of the cap-connection device 21.

For example, the vessel adapter 23 can be screwed onto the sample vessel 16 to take the vessel position in coaxial alignment with the vessel opening 18. A sealing ring 27 ensures a tight connection between the vessel adapter 23 and the sample vessel 16.

In a non-illustrated embodiment, the vessel adapter 23 is permanently attached to the sample vessel 16, so that it forms an integral component of the sample vessel 16. This embodiment is particularly suitable for plastic vessels, whereas the illustrated separate adapter solution is preferred for glass vessels.

The vessel adapter 23 can be detachably attached to the sampler housing 3 in a position designated as the adapter coupling position in the area of the sample outlet 6 in a coaxial arrangement in this regard. The adapter coupling position can be seen, for example, in FIGS. 1, 2, 3 and 5. The attachment is made by means of an adapter connection device 28, which has a first component 28a formed on the vessel adapter 23 and a second component 28b formed on the sampler housing 3, which is complementary thereto. In the adapter coupling position, the adapter opening 24 is aligned with the sample outlet 5 and is connected or connectable to the same.

Expediently, the adapter connection device 28 is designed as a screw connection device in accordance with the illustrated embodiment and has, as a first component 28a, a first thread 31a formed in the area of the front side 25a on the vessel adapter 23 and a second thread 31b complementary thereto, formed in the area of the sample outlet 6 on the sampler housing 3, wherein these threads 31a, 31b are referred to as the first and second adapter threads 31a, 31b for better differentiation. For example, the first adapter thread 31a formed on the vessel adapter 23 is an external thread and the second adapter thread 31b is an internal thread formed on the inner circumference of the sample outlet 6.

A sealing ring 30 arranged within the sample outlet 6 on the sampler housing 3 ensures a fluid-tight connection between the vessel adapter 23 and the sampler housing 3 in the adapter coupling position.

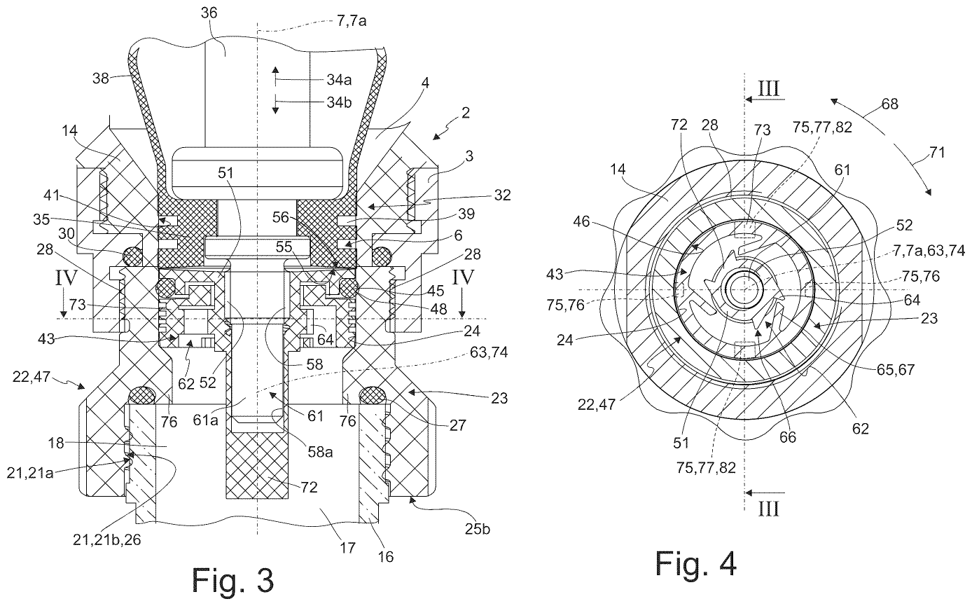

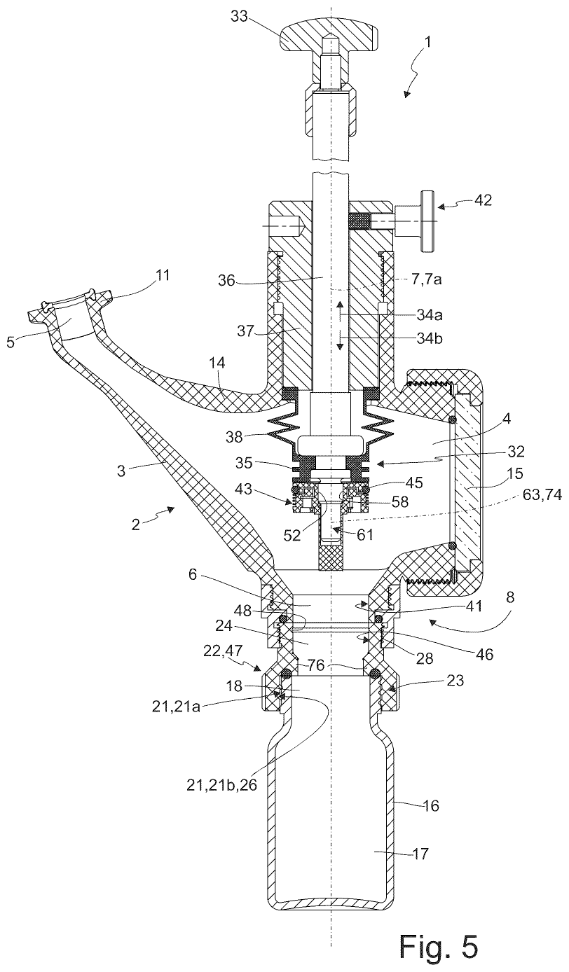

The sampler 2 is equipped with a movable valve element 32, which can be used to selectively close or open the sample outlet 6. In a valve element closure position shown in FIGS. 2 and 3, the sample outlet 6 is closed and, accordingly, so is the sample collection chamber 4, so that a sample filled in via the sample inlet 5 is contained in the sample collection chamber 4 in a hermetically sealed environment. In the valve element open position shown in FIG. 5, the valve element 32 clears the sample outlet 6, thereby allowing the sample in the sample collection chamber 4 to be transferred through the sample outlet 6 and the adapter opening 24 into the vessel interior 17.

The valve element 32 has a drive section 33 arranged outside the sample collection chamber 4, into which drive forces can be introduced in order to drive the valve element 32 selectively to perform an opening valve element movement 34a or a closing valve element movement 34b. The valve element movements 34a, 34b are performed, for example, in the height direction 7a, wherein the valve element 32 expediently has an elongated shape and also extends in the height direction 7a, protruding from the sampler housing 3 at the top of the housing.

For example, the valve element 32 has a closure section 35 at an inner end region, which is arranged in the sampler housing 3 which is arranged on an actuating rod 36 that passes through the sample collection chamber 4 and a storage section 37 of the sampler housing 3 and comprises the drive section 33 at an outer end portion arranged outside the sampler housing 3. The storage section 37 causes the actuating rod 36 to be guided in a displaceable manner so that the valve element movements 34a, 34b can be executed as precise linear movements.

The drive section 33 is designed for manual operation and is specifically configured as an operating knob. However, it can also be designed for motorised operation and can, for example, co-operate with an electro-motor operated valve element drive attached to the sampler housing 3.

For sealing in the area of the storage section 37, the longitudinal section of the actuating rod arranged within the sample collection chamber 4 is enclosed, for example, by a rubber-elastic, deformable, in particular bellows-like sealing collar 38, which is attached with a front end to the closure section 35 and with an opposite rear end in the area of the storage section 37 to the sampler housing 3 in a sealed manner. The rubber elasticity and/or bellows structure of the sealing collar 38 allows its axial compression and expansion when the valve element movements 34a, 34b are performed.

Expediently, the closure section 35 of the valve element 32 is designed like a plug, which is the case in the illustrated embodiments. In the valve element closure position, the like a plug closure section 35, as shown in FIGS. 2 and 3, immerses into the sample outlet 6 and radially seals against an inner circumferential surface 41 formed on the sampler housing 3, which radially defines the sample outlet 6 on the outside. For example, the closure section 35 is made of a rubber-elastic material so that it can directly form a sealing function with respect to the inner circumferential surface 41. Alternatively, the closure section 35 could be designed in several parts and comprise a rigid component equipped with a sealing ring. Annular grooves 39 on the outer circumference of the closure section 35 can support the elastic deformability and/or sealing.

When in the valve element open position, the closure section 35 is pulled out of the sample outlet 6 and moved into the sample collection chamber 4, wherein the distance to the sample outlet 6 is sufficiently large to allow unhindered passage of the medium to be taken as a sample.

The sampler 2 is expediently equipped with a locking-in-place device 42 that can be operated from outside the sampler housing 3, which makes it possible to lock the valve element 32 in the valve element closure position and in the valve element open position in a releasable manner so that it cannot be moved. The locking-in-place device 42 is exemplarily implemented by means of a clamping screw screwed into the sampler housing 3 and tensionable with the actuating rod 36. An alternative design provides a locking-in-place device with a locking slide that can be moved or rotated for its actuation.

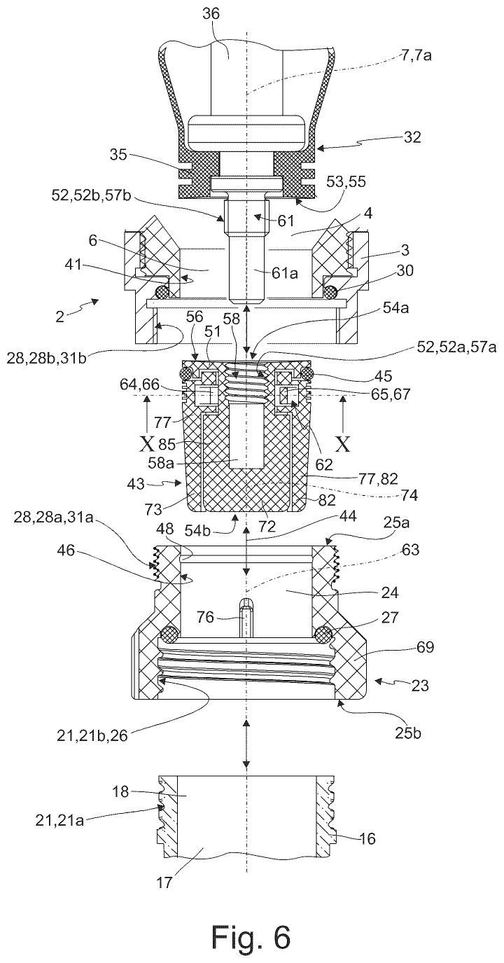

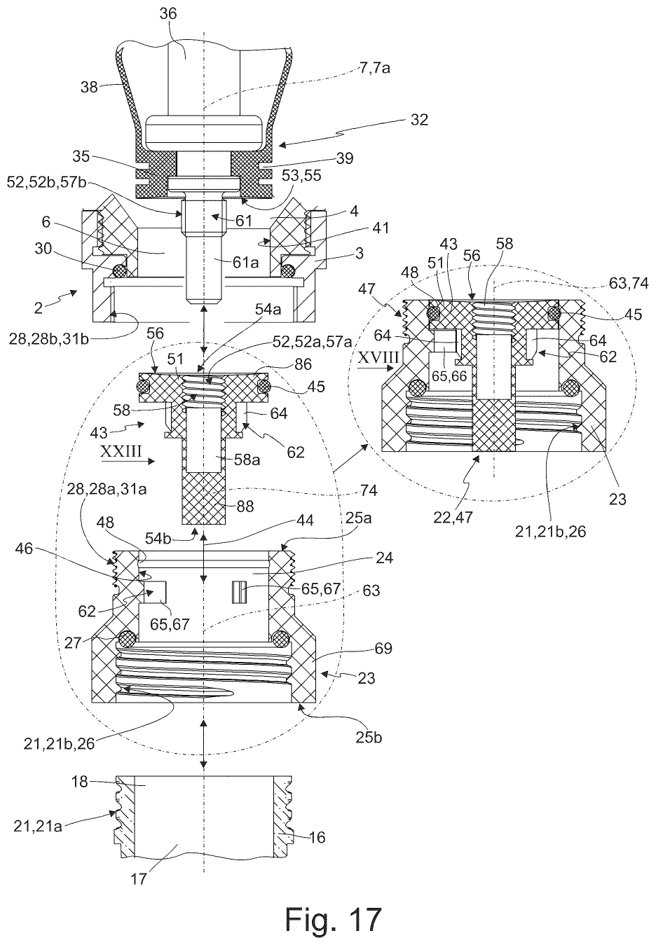

The sampling device 1 has as a further component a closure plug 43, which serves to detachably close the adapter opening 24 of the vessel adapter 23. The closure plug 43 is capable of performing linear movements relative to the vessel adapter 23, referred to as plug movements 44 and illustrated by a double arrow in FIGS. 6 and 17. In this case, the closure plug 43 is always arranged coaxially with the vessel adapter 23. As part of the plug movements 44, the closure plug 43 can be selectively positioned in a plug closure position, as shown in FIGS. 2, 3, 7 and 17 (shown in the right-hand illustration), or in a plug open position, as shown in FIGS. 5, 6 and 17 (shown there in the exploded illustration).

In the plug closure position, the closure plug 43 immerses into the adapter opening 24 from the front side 25a and rests with a ring-shaped seal 45 with radial sealing effect on an inner circumferential surface 46 of the vessel adapter 23 radially defining the adapter opening 24. In this way, the adapter opening 24 is tightly closed. In the plug open position, the closure plug 43 is pulled out of the adapter opening 24 so that the latter is open and no longer closed. In the plug open position, the closure plug 43 occupies a position spaced apart from the front side 25a of the vessel adapter 23 in the height direction 7a.

When the closure plug 43 is positioned in the plug closure position, it forms, together with the vessel adapter 23 coaxially surrounding it, a uniformly usable unit, which is referred to as the adapter-plug unit 47. The adapter-plug unit 47 is shown, for example, in FIGS. 2, 4, 7 and 17 (right-hand illustration).

The adapter-plug unit 47 is expediently prevented from accidental disintegration by means of a detachable latching mechanism. This latching is achieved by the rubber-elastic, deformable seal 45 of the closure plug 43 engaging in an annular groove 48 formed in the inner circumferential surface 46 of the vessel adapter 23 when the plug is in the plug closure position. When the closure plug 43 is pressed into the adapter opening 24 as part of a plug movement 44, the annular seal 45 snaps detachably into the annular groove 48. However, the resulting holding forces can be overcome with little effort and the closure plug 43 can be pulled out of the adapter opening 24 again if necessary.

The closure plug 43 has a fastening section 51, which comprises a first component 52a of a plug connection device 52, which enables the closure plug 43 to be detachably fastened to the valve element 32. For this purpose, the valve element 32 is equipped with a second component 52b of the plug connection device 52 that is complementary to the first component 52a. For better differentiation, the position taken by the closure plug 43 when fastened to the valve element 32 is referred to as the plug coupling position. This is clearly shown in the drawings in FIGS. 2, 3 and 5.

In the plug coupling position, the closure plug 43 is detachably attached to the valve element 32 in the area of a valve element front side 53 facing the sample outlet 6.

The closure plug 43 has an axial front 54a facing the valve element 32 in the plug coupling position and a back 54b axially opposite to this and facing away from the valve element 32. In the plug coupling position, the closure plug 43 expediently rests with its front 54a against a front face surface 55 of the closure section 35 to its front, with axial sealing contact. An axially oriented sealing surface 56 is expediently formed on the front 54a of the closure plug 43, the outer contour of which is identical to the outer contour of the front face surface 55 of the closure section 35, so that this front face surface 55 and the sealing surface 56 cover each other in the plug coupling position.

In particular, the enlarged view in FIG. 3 shows that the front sealing surface 56 of the closure plug 43 is expediently designed to be concave. This results in a high surface pressure in the outer peripheral area of the closure section 35 and the closure plug 43 in the plug coupling position, which reliably prevents the ingress of media of any kind, effectively preventing contamination of the front face surface 55 of the closure section 35 and the face surface of the closure plug 43 opposite it, arranged on the front side 54a, in the plug coupling position. In addition or alternatively, the front face surface 55 of the closure section 35 may also be designed to be concave.

Like the adapter connection device 28, the plug connection device 52 is expediently designed as a screw connection device, which applies to the illustrated embodiments. The two components 52a, 52b are designed as threads and are referred to as plug threads for better differentiation, wherein a first plug thread 57a forming the first component 52a is arranged on the fastening section 51 of the closure plug 43 and a second plug thread 57b complementary thereto, formed by the second component 52b, is arranged on the valve element 32.

The first plug thread 57a is expediently designed as an internal thread formed on the inner circumference of a fastening hole 58, which extends coaxially in the fastening section 51 and opens to the front side 54a. The fastening hole 58 may have been formed by machining or, for example, during injection moulding of the fastening section 51. The second plug thread 57b is, in this connection, an external thread formed on the outer circumference of a fastening bolt 61 representing a threaded bolt, which protrudes coaxially from the valve element front side 53 of the closure section 35. Preferably, the fastening bolt 61 is formed by an axial end portion of the actuating rod 36.

To secure it in the plug coupling position, the closure plug 43 can be screwed onto the external thread of the fastening bolt 61 using the internal thread of its fastening hole 58.

It is advantageous if the interaction between the fastening bolt 61 and the fastening hole 58 also provides centring in addition to the screw connection. This is achieved, for example, by the fastening bolt 61 comprising a threadless centring extension 61a adjoining the second plug thread 57b, which, when the closure plug 43 is screwed on, engages in a threadless centring recess 58a of the fastening hole 58 adjoining the first plug thread 57a, with mutual radial support.

When the closure plug 43 takes the plug coupling position, it forms a movement unit with the valve element 32 and always performs its valve element movements 54a, 54b in direct synchronisation.

Expediently, the closure plug 43, like the vessel adapter 23, also forms a component of the closure cap 22. For example, the closure cap 22 comprises the vessel adapter 23 and the closure plug 43 arranged thereon in the plug closure position. In other words, the adapter-plug unit 47 forms the closure cap 22 when the sample vessel 16 is in the position arranged on the vessel adapter 23.

The two plug threads 57a, 57b have, for example, the same thread pitch and the same direction of rotation. They are therefore designed either as left-hand threads with the same pitch or as right-hand threads with the same pitch. This offers the advantage that the plug threads 57a, 57b and the adapter threads 31a, 31b can, in principle, be engaged with or disengaged from each other with a uniform rotational movement of the adapter-plug unit 47 arranged on the sampler 2. Particularly relevant to the invention is the possibility of simultaneous disengagement within the scope of a loosening rotation, so that in a uniform unscrewing process, the vessel adapter 23 can be unscrewed from the sampler housing 3 and the closure plug 43 can be unscrewed from the valve element 32 at the same time.

The preferred sampling procedure is described below. This procedure assumes that the sampler 2 is attached to a media container 12 in its position of use as shown in FIGS. 1 and 2.

At the start of sampling, valve element 32 is positioned in the valve element closure position. This position results either from a previous sampling process or from explicit actuation of valve element 32 by applying a corresponding drive force to the drive section 33.

A closure plug 43 is then mounted manually in the plug coupling position on the closure section 35 using the plug connection device 52. For example, the closure plug 43 is screwed onto the fastening bolt 61 with its fastening hole 58.

A sample vessel 16 already equipped with the vessel adapter 23 is then attached to the sampler housing 3 via the vessel adapter 23 using the adapter connection device 28. The vessel adapter 23 is brought into the adapter coupling position manually. This is done, for example, by screwing the vessel adapter 23 into the sample outlet 6. Alternatively, the vessel adapter 23, which is not yet attached to the sample vessel 16, can first be mounted in the adapter coupling position on its own, whereupon the sample vessel 16 is then attached to the vessel adapter 23 using the vessel fastening structure 26.

When mounting the vessel adapter 23 on the sampler housing 3, the previously mounted closure plug 43 immerses into the adapter opening 24 and thereby obtains the plug closure position, in which it tightly seals the adapter opening 24.

This means that the adapter-plug unit 47, consisting of the closure plug 43 and the vessel adapter 23, is now also present. At this time, it functions as a closure cap 22, which keeps the vessel interior 17 closed.

In a further step, the sample collection chamber 4 closed by the valve element 32 is filled with the sample to be collected by actuating the dispensing device 13. Alternatively, this filling process can also be carried out with the sample outlet 6 closed if the vessel adapter 23 and/or the closure plug 43 are not yet installed.

Subsequently, the valve element 32 is moved into the valve element open position by applying force in the drive section 33, performing the opening valve element movement 34a, whereby the closure plug 43 attached to the valve element 32 is carried along and consequently pulled out of the adapter opening 24 and moved into the sample collection chamber 4. The closure plug 43 is now in its plug open position. As a result, the sample stored in the sample collection chamber 4 is transferred by gravity through the open sample outlet 6 and the aligned and like-wise open adapter opening 24 into the sample vessel 16.

In an alternative method, the sample outlet 6 and the adapter opening 24 are already opened by moving the valve element 32 before a sample is filled from the media container 12 into the sample collection chamber 4. In this case, the sample taken from the media container 12 is not retained in the sample collection chamber 4, but obtains direct passage through the sample collection chamber 4 without any flow interruption into the sample vessel 16 mounted by means of the vessel adapter 23.

After the sample has been filled into the sample vessel 16—if necessary, the complete emptying of the sample collection chamber 4 can be checked through the inspection glass 15—the valve element 32 is moved back to the valve element closure position by performing a closing valve element movement 34b, wherein the closure plug 43, which is moved along with it, obtains the plug closure position and closes the adapter opening 24 and thus the vessel interior 17, forming the adapter-plug unit 47. The sample is now hermetically sealed in the sample vessel 16.

At the end of the sampling process, the sample vessel 16 is removed from the sampler 3 together with the adapter-plug unit 47, while maintaining the valve element closure position of the valve element 31. The adapter plug unit 47 fixed to the sample vessel 16 takes over the function of the closure cap 22. During this removal process, both the adapter connection device 28 and the plug connection device 52 are loosened.

In the illustrated embodiments, disassembly is carried out by unscrewing the vessel adapter 23 and the closure plug 43 in such a way that both components 23, 43 are unscrewed simultaneously, which is made possible in principle by the fact that the existing screw threads have the same thread pitch and the same thread direction.

Due to the special embodiment of the adapter-plug unit 47, the illustrated embodiments offer the advantageous possibility of releasing the adapter-plug unit 47 from the sampler housing 3 and simultaneously also from the valve element 32 by simply using the detach action of the vessel adapter 23. This means that only manual access to the vessel adapter 23 is required and necessary in order to remove not only the vessel adapter 23 but also the closure plug 43 from the sampler 2. During the release process, the vessel adapter 23 functions as an actuating element that cooperates with the closure plug 43 so that the latter is also unscrewed. To remove the adapter-plug unit 47, in a preferred method of operation, a loosening torque is applied manually to the vessel adapter 23, which is transferred from the vessel adapter 23 to the closure plug 43, so that both components 23, 43 are subjected to a loosening torque. The closure plug 43 does not have to be manually applied directly.

A free wheel unit 62 integrated into the adapter-plug unit 47 is responsible for the functionality described above. On the one hand, it allows the vessel adapter 23 to be screwed on without obstruction despite the closure plug 43 already being pre-mounted in the plug coupling position and, on the other hand, it allows the vessel adapter 23 and the closure plug 43 to be unscrewed together by applying pressure to the vessel adapter 23 by hand alone.

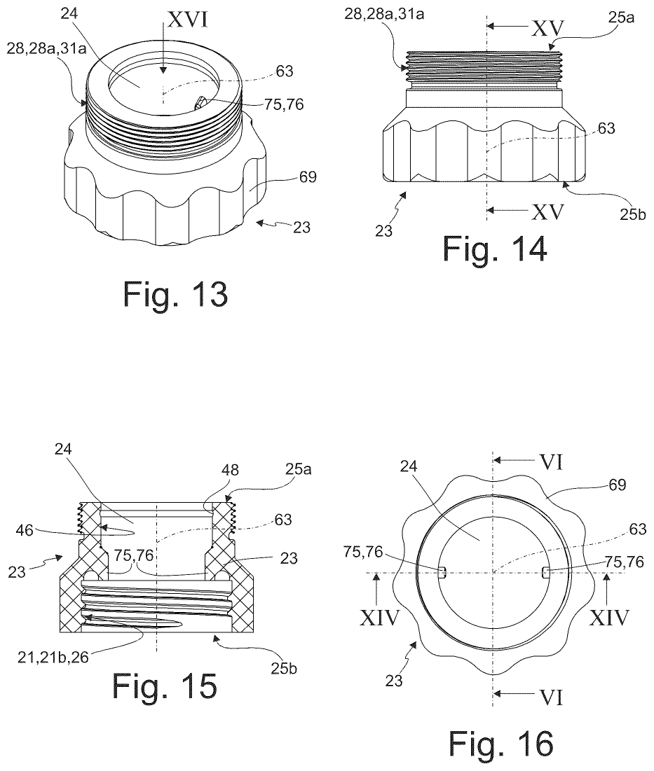

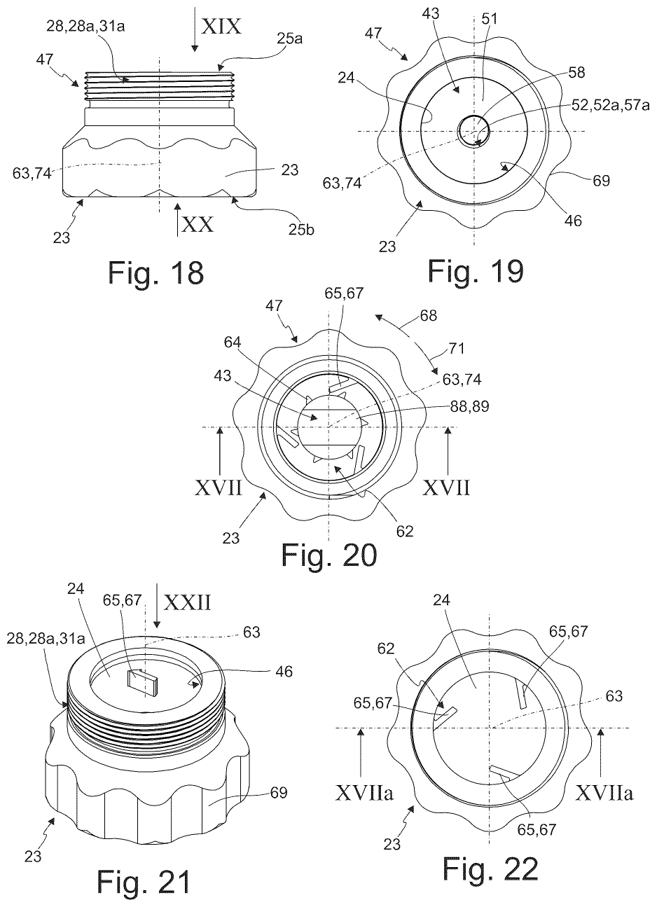

In the first embodiment shown in FIGS. 1 to 16, the free wheel unit 62 is integrated into the closure plug 43. Not illustrated is an alternative embodiment in which the free wheel unit 62 is integrated into the vessel adapter 23 instead of into the closure plug 43. The embodiment shown in FIGS. 17 to 27 pursues a further implementation in which the free wheel unit 62 is designed and arranged so that it is effective between the vessel adapter 23 and the closure plug 43.

Starting with the second embodiment shown in FIGS. 17 to 27, the closure plug 43, as a component of the adapter-plug unit 47, can be rotated relative to the vessel adapter 23 about a central longitudinal axis 63 of the adapter-plug unit 47. When the adapter-plug unit 47 is fixed to the sampler 2, the central longitudinal axis 63 is aligned coaxially with the vertical axis 7. The rotatability is unidirectional depending on the direction of rotation due to the existing free wheel unit 62, i.e. it is only possible in one direction of rotation, while in the opposite direction of rotation a rotation lock is activated.

The free wheel unit 62 contains several first blocking elements 64 arranged on the radial outer circumference of the closure plug 43 and distributed around the circumference of the closure plug 43, as well as several second blocking elements 65, which are distributed on the inner circumference of the sleeve-shaped vessel adapter 23 in its circumferential direction. The arrangement between the first and second blocking elements 64, 65 is clearly shown in FIG. 20. According to FIG. 17, they are located at the same height in the axial direction of the central longitudinal axis 63 and overlap in the radial direction relative to the central longitudinal axis 63.

The first blocking elements 64 are formed by a tooth structure 66, which is radially immovable with respect to the central longitudinal axis 63 and comprises several teeth distributed around the outer circumference of the closure plug 43 and projecting radially outwards. The second blocking elements 65 arranged on the vessel adapter 23 are formed by latching elements 67 that are resiliently movable relative to the vessel adapter 23 in a radial direction with respect to the central longitudinal axis 63. These latch elements 67 are performed in particular as pawls which project obliquely radially inwards from the inner circumferential surface 46 of the vessel adapter 23, so that they have a directional component in the circumferential direction of the central longitudinal axis 63 in addition to the radial directional component. The latch elements 67 are spring-loaded against the tooth structure 66.

In order to screw the vessel adapter 23 onto the sampler housing 3 with the closure plug 43 already screwed onto the valve element 32, it is turned manually by applying torque in a fastening direction of rotation 68. To do this, it can be gripped by a handling structure 69 formed on its radial outer circumference, in particular with a polygonal contour. The first and second blocking elements 64, 65 are designed in such a way that, in this fastening direction of rotation 68, there is a free-running state in which the spring-elastic latching elements 67 can slide over the tooth structure 66 without a locking function, so that the vessel adapter 23 can be screwed on regardless of the already fastened closure plug 43.

If, on the other hand, the vessel adapter 23 is turned in a loosening direction of rotation 71 opposite to the fastening direction of rotation 68 when the adapter-plug unit 47 is mounted on the sampler 2, the latch elements 67 wedge themselves into the tooth structure 66, resulting in a blocking state that causes torque to be transmitted from the vessel adapter 23 to the closure plug 43. As a result, the closure plug 43 is turned and the entire adapter-plug unit 47 can be unscrewed from the sampler 2 by simply the vessel adapter detach action.

In the embodiment shown in FIGS. 1 to 17, the closure plug 43, apart from the optional seal 45, can be formed in a cost-effective manner as a single piece. The same applies to the vessel adapter 23.

It is understood that the assignment of the first and second blocking elements 64, 65 to the closure plug 43 and to the vessel adapter 23 can also be reversed.

In the embodiment shown in FIGS. 1 to 16, the closure plug 43 has, as in the first embodiment, a closure plug longitudinal axis 74 which, when the adapter-plug unit 47 is assembled, coincides with its central longitudinal axis 63. However, the closure plug 43 is divided here into two elements that are coaxial with respect to the closure plug longitudinal axis 74 and enclose each other, which are referred to as the first free wheel element 72 and the second free wheel element 73. The two free wheel elements 72, 73 are inserted into one another so that the first free wheel element 72 is radially enclosed by the second free wheel element 73. The first free wheel element 72 comprises the fastening section 51, on which the first component 52a of the plug connection device 52 is formed.

The two free wheel elements 72, 73 can rotate relative to each other around the closure plug longitudinal axis 74, but only unidirectionally in one of the two possible directions of rotation. The reason for this are first blocking elements 64 formed on the outer circumference of the first free wheel element 72 and second blocking elements 65 formed on the inner circumference of the second free wheel element 73. The same explanations apply to the design and arrangement of the first and second blocking elements 64, 65 as to the embodiment shown in FIGS. 17 to 27, so reference is made thereto to avoid repetition. In any case, the first and second blocking elements 64, 65 cause the two free wheel elements 72, 73 to be locked depending on the direction of rotation. In a first direction of rotation of the second free wheel element 73, the free-running state prevails, in which no torque is transmitted, and in a second direction of rotation of the second free wheel element 73 opposite to this, a blocking state prevails, in which the second free wheel element 73 is coupled to the first free wheel element 71 in a torque-transmitting manner.

Between the second free wheel element 73 and the vessel adapter 23 surrounding the closure plug 43, a follower structure 75 is effective, which is composed, for example, of several first followers 76 formed on the inner circumferential surface 46 of the vessel adapter 23 and radially inwardly projecting first followers 76 formed on the inner circumferential surface 46 of the vessel adapter 23 and a plurality of second followers 77 formed in the area of the outer circumference on the second free wheel element 73. Exemplarily, the first and second followers 76, 77 are each present in pairs diametrically opposite one another, but they may also be present individually without further ado. In any case, the arrangement is such that the first and second followers 76, 77 overlap in a radial direction relative to the central longitudinal axis 63. The follower structure 75 is effective in both possible directions of rotation of the vessel adapter 23, so that the second free wheel element 73 is driven in each direction of rotation of the vessel adapter 23. However, there is, for example, an idle space between the two drive positions, which is caused by the circumferential distance between the first and second followers 76, 77.

When the vessel adapter 23 is manually rotated in a fastening direction of rotation 68 to screw it onto the sampler housing 3, the second free wheel element 73 of the closure plug 43 pre-mounted on the valve element 32 is carried along in the first direction of rotation, in which the non-locking free-running state of the free wheel unit 62 is present. In this way, the vessel adapter 23 can be screwed on regardless of the fact that the closure plug 43 has already been fastened to the valve element 32 in the plug coupling position with its fastening section 51. When the vessel adapter 23 is turned in the opposite loosening direction of rotation 71 to unscrew it from the sampler housing 3, it again drives the second free wheel element 73, but now in the second direction of rotation, in which the free wheel unit 62 is in the blocking state. As a result, the first free wheel element 72, which comprises the fastening section 51, is also turned, causing the closure plug 43 to be unscrewed from the sampler 2 together with the vessel adapter 23.

The plural form used to designate the first and second blocking elements 64, 65 in all embodiments should be understood to mean that they may also be present in the singular.

According to the illustrated embodiments, it is advantageous if the fastening section 51 is disc-shaped and comprises the annular seal 45 in the area of its radial outer circumference. In the plug closure position, the face sealing surface 46 formed thereon expediently runs flush with the front side 25a of the vessel adapter 23 pointing in the same direction. The components of the free wheel unit 63 are preferably arranged on the side of the fastening section 51 axially opposite the end sealing surface 56.

In the first embodiment shown in FIGS. 1 to 16, the second free wheel element 73 expediently has an annular head section 78 on which the second blocking elements 65 projecting radially inwards are arranged. Two expediently diametrically opposed arms 82 project from the annular head section 78 with free ends towards the back 54b, each forming one of the two second followers 77.

The annular head section 78 of the second free wheel element 73 preferably comprises several annular grooves 81 on its radial outer circumference, which are coaxial with each other and spaced axially from each other, which can exert a sealing effect in the plug closure position of the closure plug 43 by interacting with the inner circumferential surface 46 of the vessel adapter 23 surrounding them.

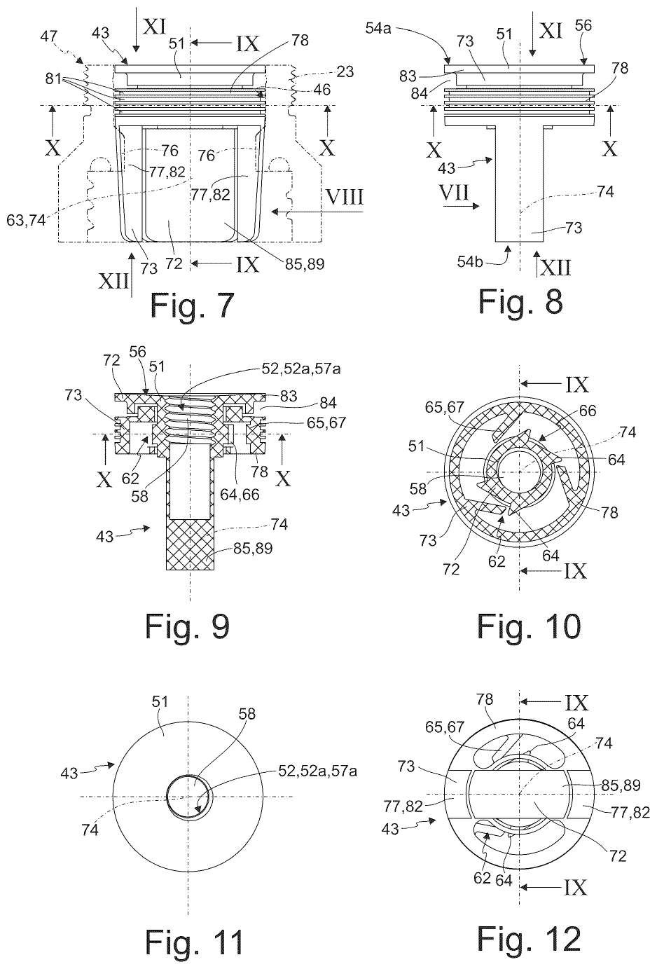

The first free wheel element 72 expediently has a disc-shaped head section 83 forming the fastening section 51, which is located in front of the annular head section 78 of the second free wheel element 73 towards the front 54a. The two head sections 78, 83 together define, for example, an annular recess 84 in which the annular seal 45, not shown in FIGS. 7 to 12, is held. An expedient central extension 85 of the first free wheel element 71, which comprises a flat region at least at its end region and passes through the annular head section 78, protrudes from the disc-shaped head section 83 between the two arms 82 in the direction of the back 54b, which forms a hand-operated section 89 and can be easily grasped with the fingers of one hand in order to screw the closure plug 43 onto the valve element 32.

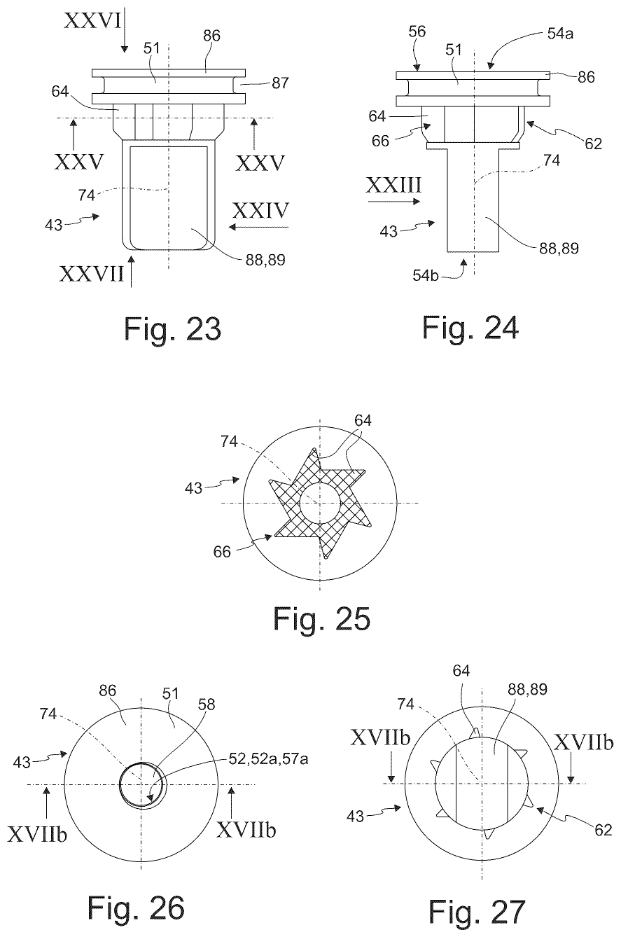

In the second embodiment shown in FIGS. 17 to 27, the sealing plug 43 expediently has a disc-shaped head section 86 forming the fastening section 51, which comprises an annular recess 87 on its radial outer circumference, in which the annular seal 45, not shown in FIGS. 23 to 27, is held. A central extension 88, which comprises a flat configuration at least at its end region, protrudes expediently from the disc-shaped head section 86 in the direction of the back 54b, forming a hand-operated section 89 that can be easily grasped with the fingers of one hand in order to screw the closure plug 43 onto the valve element 32.

1. A sampling device comprising:
a sampler that comprises a sampler housing which defines a sample collection chamber for receiving a sample to be taken and which has a sample inlet communicating with the sample collection chamber for introducing a sample to be taken, and
a sample outlet communicating with the sample collection chamber for discharging the sample contained in the sample collection chamber into a sample vessel fixed to the sampler and defining a vessel interior,
wherein,
the sampler has a valve member which is movable relative to the sampler housing to selectively open or close the sample outlet-by performing valve element movements, which comprises a closure section which, in a valve element closure position, seals the sample outlet tightly and, in a valve element open position, is displaced into the sample collection chamber and clears the sample outlet for sample passage, wherein the sampling device further comprises a sleeve-shaped vessel adapter which can be attached or is attached to the sample vessel in a vessel position in the area of a vessel opening, which is traversed axially by an adapter opening connected to the vessel interior in the vessel position,
wherein the sampling device further comprises a closure plug which can be moved both into a plug closure position inserted into the adapter opening and thereby tightly sealing the adapter opening and into a plug open position pulled out of the adapter opening and thereby clearing the adapter opening, wherein the vessel adapter and the closure plug together form an adapter-plug unit in the plug closure position,
wherein parts of a plug connection device are arranged on the valve element and on a fastening section of the closure plug, by means of which the closure plug can be detachably fastened to the valve element in a plug coupling position, wherein the closure plug follows the valve element movements of the valve element,
wherein parts of an adapter connection device are arranged on the sampler housing and on the vessel adapter, by means of which the vessel adapter can be detachably fastened to the sampler housing in an adapter coupling position, wherein the adapter opening is connected to the sample outlet,
wherein, while the valve element is in the valve element closure position, the closure plug can be brought into the plug coupling position attached to the valve element and the vessel adapter can be brought into the adapter coupling position attached to the sampler housing forming the adapter-plug unit, so that the adapter-plug unit is attached to the sampler on the one hand via the sampler housing and on the other hand via the valve element,
wherein the adapter opening can initially be cleared by valve element movements of the valve element due to the closure plug moving with the valve element, so that a sample contained in the sample collection chamber can be transferred to a sample vessel arranged on the vessel adapter and enclosed therein, and
wherein the adapter-plug unit is detached in the valve element closure position of the valve element while maintaining the plug closure position of the closure plug by releasing both the adapter connection device and the plug connection device together with a sample vessel-attached to the vessel adapter from the sampler.

2. The sampling device according to claim 1, wherein the closure section of the valve element is plug, wherein the plus is immersed in the sample outlet in the valve element closure position and radially abuts against an inner circumferential surface formed on the sampler and surrounding the sample outlet in a sealing manner to close the sample outlet.

3. The sampling device according to claim 1, wherein the plug connection device and the adapter connection device can be detached simultaneously from the sampler in order to separate the adapter-plug unit.

4. The sampling device according to claim 1, wherein the adapter-plug unit can be detached from the sampler by a single detach action of the vessel adapter from both the sampler housing and the valve element.

5. The sampling device according to claim 1, wherein the plug connection device and the adapter connection device are each designed as a screw connection device, wherein the plug connection device comprises a first plug thread formed on the closure plug and a second plug thread formed on the valve element and complementary thereto, and wherein the adapter connection device comprises a first adapter thread formed on the vessel adapter and a second adapter thread formed on the sampler housing and complementary thereto, wherein the first and second plug threads can be brought into or out of mutual engagement by rotating the closure plug and the first and second adapter threads can be brought into or out of mutual engagement by rotating the vessel adapter, depending on the direction of rotation.

6-7. (canceled)

8. The sampling device according to claim 5, wherein the adapter-plug unit comprises a free wheel unit which, on the one hand, when torque is applied to the vessel adapter in a fastening direction of rotation, allows the vessel adapter to rotate relative to the fastening section of the closure plug about a central longitudinal axis of the adapter-plug unit, so that the vessel adapter can be fastened to the sampler housing via the adapter connection device independently of the closure plug, and on the other hand, when a torque is applied to the vessel adapter in a loosening direction of rotation opposite to the fastening direction of rotation, allows the vessel adapter to rotate, taking the closure plug with it, so that the adapter-plug unit can be detached uniformly and simultaneously from the adapter connection device and the plug connection device by the sampler housing and the valve element

9. The sampling device according to claim 8, wherein the free wheel unit is effective between the vessel adapter and the closure plug.

10. The sampling device according to claim 9, wherein first and second blocking elements of the free wheel unit, which can be locked and unlocked depending on the direction of rotation, are arranged on the vessel adapter and on the closure plug.

11. The sampling device according to claim 8, wherein the free wheel unit is integrated into the closure plug or into the vessel adapter,

12. The sampling device according to claim 11, wherein the free wheel unit comprises a first free wheel element and a second free wheel element that can rotate relative to it, which are equipped with first and second blocking elements, that can be locked and unlocked depending on the direction of rotation, wherein a follower structure is effective between the second free wheel element and the closure plug or vessel adapter not comprising a free wheel unit, which, when the closure plug or vessel adapter not comprising a free wheel unit is rotated in either direction, causes the second free wheel element to be driven in rotation.

13. The sampling device according to claim 12, wherein the free wheel unit is integrated into the closure plug, wherein the first free wheel element comprises the fastening section of the closure plug and the second free wheel element is coupled to the vessel adapter via the follower structure in both directions of rotation of the vessel adapter in a torque-transmitting manner.

14. The sampling device according to claim 10, wherein the first blocking elements are formed by a tooth structure that is radially immovable relative to the central longitudinal axis of the adapter-plug unit and the second blocking elements-are formed by radially spring-elastically movable latch elements relative to the central longitudinal axis of the adapter-plug unit, or vice versa.

15. The sampling device according to claim 1, wherein the closure plug is detachably latched to the vessel adapter in the plug closure position, by engagement of an annular seal provided for sealing between the closure plug and the vessel adapter in an annular groove.

16. The sampling device according to anyone claim 1, wherein the closure plug in the plug coupling position seals against a concave-shaped sealing surface on a front face surface of the closure section of the valve element resting against it, wherein the diameter of the sealing surface and the diameter of the front face surface of the closure section are identical.

17. The sampling device according to claim 1, wherein the valve element comprises an actuating rod which supports the closure section and protrudes from the sampler housing, which comprises a longitudinal section extending into the sample collection chamber, which is enclosed by a rubber-elastic, deformable sealing collar, which is axially fixed in a sealed manner at one end to the closure section and at the other end to the sampler housing.

18. The sampling device according to claim 1, wherein the sampler comprises a vertical axis-relative to which the sample outlet is arranged coaxially and which is expediently aligned vertically in a position of use of the sampler.

19. The sampling device according to ref claim 1, wherein the sampler housing comprises an inspection glass that allows the sample collection chamber to be viewed.

20. The sampling device according to claim 1, wherein the valve element is assigned a locking-in-place device for locking the valve element in the valve element open position and/or in the valve element closure position in a manner that is immovable relative to the sampler housing and can be released.

21. A method for sampling using a sampling device with a sampler that comprises a sampler bousing which defines a sample collection chamber for receiving a sample to be taken and which has a sample inlet communicating with the sample collection chamber for introducing a sample to be taken, and a sample outlet communicating with the sample collection chamber for discharging the sample contained in the sample collection chamber into a sample vessel fixed to the sampler and defining a vessel interior,
wherein,
that the sampler bas a valve member which is movable relative to the sampler housing to selectively open or close the sample outlet by performing valve element movements, which comprises a closure section which, in a valve element closure position, seals the sample outlet tightly and, in a valve element open position, is displaced into the sample collection chamber and clears the sample outlet for sample passage,
that the sampling device comprises a sleeve-shaped vessel adapter which can be attached or is attached to the sample vessel in a vessel position in the area of a vessel opening which is traversed axially by an adapter opening connected to the vessel interior in the vessel position,
that the sampling device comprises a closure plug which can be moved both into a plug closure position inserted into the adapter opening and thereby tightly sealing the adapter opening and into a plug open position pulled out of the adapter opening and thereby clearing the adapter opening, wherein the vessel adapter and the closure plug together form an adapter-plug unit in the plug closure position,
that parts of a plug connection device are arranged on the valve element and on a fastening section of the closure plug, by means of which the closure plug can be detachably fastened to the valve element in a plus coupling position, wherein the closure plus follows the valve element movements of the valve element,
and that parts of an adapter connection device are arranged on the sampler bousing and on the vessel adapter, by means of which the vessel adapter can be detachably fastened to the sampler housing in an adapter coupling position, wherein the adapter opening is connected to the sample outlet,
wherein, while the valve element is in the valve element closure position, the closure plug can be brought into the plus coupling position attached to the valve element and the vessel adapter can be brought into the adapter coupling position attached to the sampler housing, forming the adapter-plug unit, so that the adapter-plug unit is attached to the sampler on the one band via the sampler housing and on the other hand via the valve element,
wherein the adapter opening can initially be cleared by valve element movements of the valve element due to the closure plug moving with the valve element, so that a sample contained in the sample collection chamber can be transferred to a sample vessel arranged on the vessel adapter and enclosed therein,
wherein the adapter plug unit is detached in the valve element closure position of the valve element while maintaining the blue closure position of the closure plug by releasing both the adapter connection device and the plug connection device together with a sample vessel attached to the vessel adapter from the sampler wherein the sampler, wherein the sampler is connected in a position of use with its sample inlet to a media container which contains a flowable medium from which a sample is to be taken,
the method comprising:
providing a sample vessel, a vessel adapter and a closure plug,
positioning the valve element of the sampler in the valve element closure position,
manually fastening the closure plug in the plug coupling position to the valve element in the valve element closure position by means of the plug connection device,
subsequently manually fastening the vessel adapter in the adapter coupling position in the area of the sample outlet of the sampler housing using the adapter connection device, wherein the pre-assembled closure plug is inserted into the adapter opening of the vessel adapter to be in the plug closure position, so that the adapter opening is closed by the closure plug, forming the adapter-plug unit,
attaching the sample vessel to the vessel adapter before or after it is fastened in the adapter coupling position,
transferring a sample introduced into the sample collection chamber from the sample collection chamber into the sample vessel fixed to the sampler housing via the vessel adapter, by first clearing and then closing the adapter opening by means of valve element movements of the valve element as a result of the closure plug following the valve element movements so that the sample contained in the sample collection chamber is transferred through the opened adapter opening into the sample vessel and enclosed in its interior and
removing the sample vessel from the sampler together with the adapter-plug unit which now functions as a closure cap, in the valve element closure position of the valve element by detaching both the adapter connection device and the plug connection device while maintaining the plug closure position of the closure plug.

22. The method for sampling according to claim 21, wherein the filling of the medium to be sampled into the sample collection chamber takes place with the valve element in the valve element closure position before or after the attachment of the adapter-plug unit to the sampler, or with the valve element in the valve element open position, after the adapter-plug unit has been attached to the sampler.

23. (canceled)
